(19) United States
(12) Patent Application Publication
(10) Pub. No.: US 2010/0166914 A1
(43) Pub. Date: Jul. 1, 2010

(54) CENTER-FILLED CONFECTIONERY PRODUCTS

(75) Inventors: Daniel L. Herron, Chicago, IL (US); Christina Wowchuk, Chicago, IL (US); Kenneth Klacik, Hillsborough, NJ (US); Richard W. Deptula, Budd Lake, NJ (US)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/520,383

(22) PCT Filed: Dec. 20, 2007
(86) PCT No.: PCT/US07/88283

§ 371 Date: Mar. 15, 2010

(30) Foreign Application Priority Data
Dec. 21, 2006 (US) 60871411

(51) Int. Cl. A23G 3/54; A23L 1/48; A23G 1/50; A23G 1/54; A23G 3/50; A23P 1/00

(52) U.S. Cl. 426/61; 426/103; 426/93; 426/102; 426/96; 426/249; 426/512

(57) ABSTRACT

Center-filled confectionery products and methods of making center-filled confectionery products are provided. In an embodiment, the present invention provides a confectionery product comprising a hard confectionery shell surrounding a filling. The confectionery shell comprises a plurality of segments having different colors. The filling is selected from the group consisting of a liquid, a paste, a powder, a hard confectionery and combinations thereof.

### BACKGROUND

The present disclosure relates generally to confectionery products. More specifically, the present disclosure relates to center-filled confectionery products and methods of making same.

Confectionery products or compositions having a liquid center-fill can include, for example, chewing gum or candy. It is generally known that confectionery products having unique flavors and visually pleasing appearances can lead to enhanced marketability with consumers.

### SUMMARY

The present disclosure relates to center-filled confectionery products and methods of making center-filled confectionery products. For example, in an embodiment, the present disclosure provides a confectionery product comprising a hard confectionery shell surrounding a filling. The confectionery shell comprises two or more segments having different colors and/or flavors (e.g. each adjacent segment has a different color/flavor). In this embodiment, the filling can be, for example, a liquid, a paste, a powder, a hard confectionery and combinations thereof.

In an embodiment, the filling can be, for example, a chocolate, compound coating, cocoa powder, cocoa liquor and combinations thereof. The filling can also be, for example, fondant, caramel, nougat and combinations thereof. Further, the filling can be peanut butter, nut paste and combinations thereof.

In an embodiment, the filling comprises a fruit-based product.

In an embodiment, the fruit-based product can be, for example, fruit pieces, freeze dried fruit, drum dried fruit, infused fruit, crushed fruit, squeezed fruit, fruit extract, fruit oil, fruit paste, fruit powder, fruit particulates, fruit juice and combinations thereof.

In an embodiment, the segments of the hard confectionery shell have varying widths.

In an embodiment, the hard confectionery shell comprises at least one ingredient such as, for example, malted products, sweeteners, flavors, colors, sensates, acids, medicaments, actives and combinations thereof.

In an embodiment, the filling comprises at least one ingredient such as, for example, malted products, sensates, medicaments, actives and combinations thereof.

In an embodiment, the confectionery product comprises little or no trans fat.

In an embodiment, the confectionery product comprises little or no saturated fat.

In an embodiment, the hard confectionery shell and/or filling comprises a texture changing ingredient such as, for example, acids, enzymes and combinations thereof.

In an alternative embodiment, the present disclosure provides a method of making a hard center-filled confectionery product. The method comprises dispensing a first confectionery through a first outer passage of a nozzle and dispensing a second confectionery through a second outer passage of the nozzle. The second confectionery comprises at least one different characteristic from the first confectionery. The method also comprises dispensing a filling through an inner chamber of the nozzle and co-depositing the first confectionery, the second confectionery and the filling. The first confectionery and the second confectionery form a plurality of adjacent segments that completely surround the filling to form the hard center-filled confectionery product.

In an embodiment, the characteristic is selected from the group consisting of color, flavor, texture, moisture content, fat content and combinations thereof.

In still another embodiment, the present disclosure provides a method of making a hard center-filled confectionery product. The method comprises dispensing a plurality of streams of a first confectionery in fluid form through corresponding first outer passages of a nozzle and dispensing a plurality of streams of a second confectionery in fluid form through corresponding second outer passages of the nozzle. The second confectionery comprises at least one different characteristic from the first confectionery. The method also comprises dispensing a filling through an inner chamber of the nozzle. A portion of the first confectionery streams and the second confectionery streams is deposited into a mould. The filling is deposited on top of the portion of the first confectionery streams and the second confectionery streams. The first confectionery streams and the second confectionery streams are deposited in the mould to form a plurality of adjacent segments that completely surround the filling.

In an embodiment, the method comprises cooling the first confectionery streams and the second confectionery streams in the mould to form the hard center-filled confectionery product.

In an alternative embodiment, the present disclosure provides a method of making a hard center-filled confectionery product. The method comprises partially enrobing a filling within a confectionery shell using a concentric nozzle. The confectionery shell comprises a plurality of segments having different characteristics. The method also comprises depositing the partially enrobed filling in a cavity of a mould, completely enrobing the filling component within the confectionery shell, and setting the confectionery shell within the mould cavity to form the hard center-filled confectionery product.

An advantage of the present disclosure is to provide a center-filled confectionery having a unique confectionery appearance.

Another advantage of the present disclosure is to provide a center-filled confectionery product that unique confectionery flavors.

Still another advantage of the present disclosure is to provide an improved process for making center-filled confectionery products.

Additional features and advantages are described herein, and will be apparent from, the following Detailed Description and the Figures.

### BRIEF DESCRIPTION OF THE FIGURES

FIG. 1 illustrates a perspective view of the center-filled confectionery product in one embodiment of the present disclosure.

FIG. 2 illustrates a cross-section view of the center-filled confectionery product taken substantially along line II-II of FIG. 1.

FIG. 3 illustrates a perspective view of a nozzle for making the center-filled confectionery product in an embodiment of the present disclosure.

FIG. 4 illustrates a cross-section view of the nozzle taken substantially along line IV-IV of FIG. 3.

### DETAILED DESCRIPTION

The present disclosure relates to confectionery products. More specifically, the present disclosure relates to center-filled confectionery products having a plurality of segments and methods for the center-filled confectionery products. In an embodiment, the confectionery product has a uniqueness of a hard candy shell surrounding a soft filling such as, for example, chocolate.

As used herein, the term “hard confectionery” means a hard boiled or glassy candy as understood by the skilled artisan.

As used herein, the term “segment” means a region of one color (or other suitable characteristic such as flavor, texture, etc.) extending from a point on the surface of the confectionery product and gradually extending toward the outer edge of the candy piece, in which the color extends through the piece to the other surface. The color can gradually increase in width as it extends toward the outer edge of the candy piece. In an embodiment, the segments begin from approximately one side of the top surface of the confectionery, and the widths of the various segments at the outer edge of the candy differ one from another.

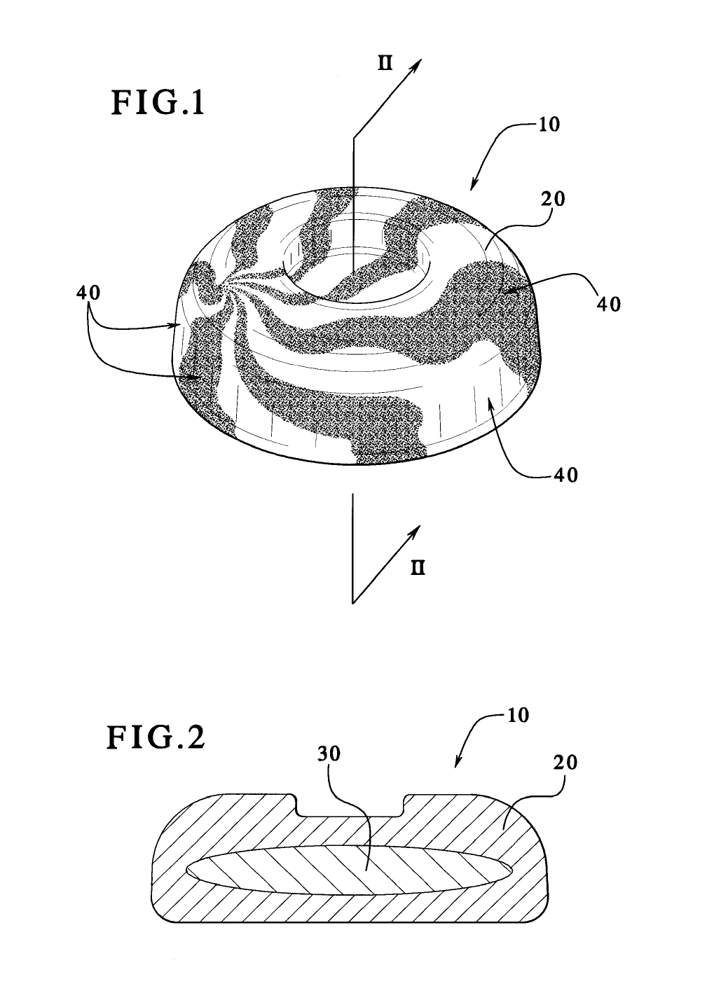

In an embodiment illustrated in FIGS. 1-2, the present disclosure provides a confectionery product 10 comprising a plurality of segments. The confectionery product 10 comprises a hard confectionery shell 20 surrounding a filling 30. The hard confectionery shell 12 comprises a plurality of segments 40. For example, the plurality of segments comprises adjacent segments 40 as illustrated in FIG. 1 with each segment having a different characteristic such as a color/flavor from an adjacent segment.

It should be appreciated that the confectionery shell 20 and the filling 30 can comprise any suitable amount by weight of the entire confectionery product 10. For example, the confectionery shell 20 can comprise from about 50% to about 95% by weight of the confectionery product 10. The filling 30 can comprise from about 5% to about 50% by weight of the confectionery product 10.

In an embodiment, each segment can extend from the center or any point on the top surface of the confectionery product in a generally triangular shape out to the peripheral edges of the confectionery product. It should be appreciated that the segment can extend from any location on the surface of the confectionery product. The boundaries between adjacent segments can be any suitable shape such as, for example, straight, curved, swirled and combinations thereof.

In an alternative embodiment, the widths of the adjacent segments can vary from each other along their entire lengths. The pattern of varying widths can be seen all the way around the confectionery product. The segments can also extend axially through the confectionery product from the top surface to the bottom surface. It should be appreciated the segments can comprise any suitable widths. Preferably, the widths can range from approximately 0.05 inch to 0.50 inch. The width and/or border shape of each segment can be the same or vary to a degree to give the confectionery product an aesthetically pleasing appearance.

It should be appreciated that the confectionery products can comprise any number of segments. Preferably, the number of segments ranges from 2-20. More preferably, the number of segments ranges from 10-14. In an embodiment, the confectionery product comprises two colors, for example, arranged in alternating segments. The confectionery product can also comprise three or more colors arranged in any suitable order so that the adjacent segments each comprise a different color.

The confectionery shell can comprise any suitable colors (e.g. red, brown, blue, green, yellow, orange) or flavors (e.g. raspberry, orange, strawberry, lemon, grape, apple, pear, peach, cherry, caramel). It should be appreciated that the hard confectionery is capable of forming a shell or casing surrounding a liquid, paste, powder or solid filling. The filling can comprise, for example, a component selected from the group consisting of a chocolate, compound coating, cocoa powder, cocoa liquor, fondant, caramel, nougat, peanut butter and combinations thereof.

In another embodiment, the filling can comprise a fruit-based product such as, for example, fruit pieces, freeze dried fruit, drum dried fruit, infused fruit, crushed fruit, squeezed fruit, fruit extract, fruit oil, fruit paste, fruit powder, fruit particulates, fruit juice and combinations thereof. The fruit could be in the form of particles or pieces, as in a larger grind of fruit or in combination of other ingredients, such as sugar. These ingredients would be used to give an alternative texture and/or further flavor enhancement and/or visual enhancement against the base confection material. The fruit-based product may comprise any suitable fruit such as, for example, raspberry, orange, strawberry, lemon, grape, apple, pear, peach, cherry, plum, pineapple, apricot etc.

In an alternative embodiment, the center-filled confectionery products can comprise little or no trans fat. The trans fat content could be an amount that that will allow the confectionery product to be labeled as “low trans” and/or as “zero trans.” For example, trans fats generally include palm, coconut and other tropical oils/fats and totally hydrogenated vegetable oils. Alternatively, the center-filled confectionery products can comprise little or no saturated fat content. The saturated fat content could be in an amount that would allow the confectionery product to be labeled as “low saturated fats” and/or as “zero saturated fats.” For example, in alternative embodiments, fats containing saturated fats, such as vegetable oils, would be avoided.

The confectionery products 10 can comprise any suitable weight. Preferably, the weight of the confectionery product 10 ranges from about 1 to about 50 grams. Preferably, the weight of the confectionery product 10 ranges from about 2 to about 6 grams.

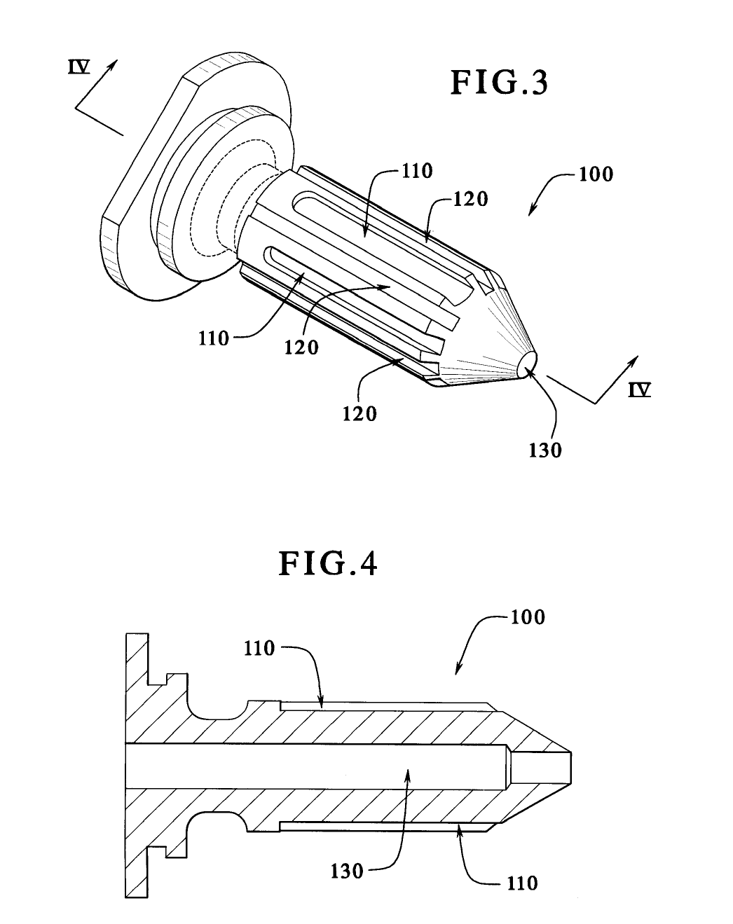

In an alternative embodiment, the present disclosure provides a method of making a hard center-filled confectionery product using a nozzle 100 as illustrated in FIGS. 3-4. The method comprises dispensing (e.g. distributing, supplying or circulating) a first confectionery through one or more first outer passages of a nozzle 100 and dispensing a second confectionery through one or more second outer passages of the nozzle 100. For example, the first and second outer passages are formed from passages made when the nozzle 100 comprising slots 110 and slots 120 is placed into a manifold opening of a depositor (not shown). The walls of the manifold combine with slots 110 and slots 120 to form separate passages for the first confectionery and the second confectionery to travel through during the depositing. The number of passages can correspond to the number of segments in the desired confectionery product.

The second confectionery comprises at least one different characteristic from the first confectionery. The differing characteristics can be based on, for example, color, flavor, texture, moisture content, fat content and combinations thereof.

The first confectionery and the second confectionery are in a form where they can flow into the first and second passages, respectively, from hoppers holding the first confectionery and the second confectionery. For example, the hoppers and the nozzle/manifold assembly can be heated and maintained at a suitable temperature to ensure that the first and second confectioneries are in a fluid form prior to being deposited. Delivering the confectioneries via the first and second outer passages allows the first confectionery and second confectionery to remain separate to retain their distinct characteristics until they are combined in a mould.

The method also comprises dispensing a filling through an inner chamber 130 of the nozzle 100. The filling can be in a separate hopper than the first and second confectioneries.

The first confectionery, the second confectionery and the filling are co-deposited into a mould (not shown). For example, the first confectionery and the second confectionery form a plurality of adjacent segments equal to the number of external slots in the nozzle 100 that completely surround the filling. The method can further comprise cooling the first confectionery and the second confectionery in the mould to form the hard center-filled confectionery product.

In still another embodiment, the present disclosure provides a method of making a center-filled confectionery product. The method comprises dispensing a plurality of streams of a first confectionery in fluid form through corresponding first outer passages of a nozzle and dispensing a plurality of streams of a second confectionery in fluid form through corresponding second outer passages of the nozzle. For example, each confectionery stream can be dispensed through a separate outer passage. The nozzle/manifold can be designed in a manner and arranged in connection with the confectionery containing hoppers so that the first and second confectionery streams can be alternately dispensed through passages surrounding the nozzle.

The method also comprises dispensing a filling such as, for example, a chocolate through an inner chamber of the nozzle. A portion of the plurality of the first confectionery streams and a portion of the plurality of the second confectionery streams is deposited into a mould. The filling is deposited on top of the portion of the first confectionery streams and the second confectionery streams. The first confectionery streams and the second confectionery streams are deposited in the mould to form a plurality of adjacent segments that completely surround the filling.

The flow of the first and second confectionery streams are then stopped or cut off leaving a final confectionery product comprising adjacent segments of the first and the second confectioneries streams surrounding the filling. The method can further comprise cooling the first confectionery and the second confectionery streams in the mould and removing the final product from the mould by inverting the mould and pushing out the final product with an injection pin at the bottom of the mould.

In an alternative embodiment, the present disclosure provides a method of making a hard center-filled confectionery product. The method comprises partially enrobing a filling within a confectionery shell using a concentric nozzle. The confectionery shell comprises a plurality of segments having different characteristics. The method also comprises depositing the partially enrobed filling in a cavity of a mould, completely enrobing the filling component within the confectionery shell, and setting the confectionery shell within the mould cavity to form the hard center-filled confectionery product.

The confectionery product can be individually deposited in a mould or on a belt. The confectionery product can also be deposited adjacently and in contact with each other, for example, to form a single product having a plurality of confectionery sections. The size of the deposited piece(s) can vary accordingly to achieve the desired final product. In should be appreciated that depositing can also comprise layering, leaving and/or extruding and any other similar processes for delivering one or more segments of flowable confectionery material at depositing temperatures.

It should be appreciated that the confectionery products in various embodiments of the present disclosure can be made by any suitable method known by those skilled in the art. For example, the center-filled confectionery product can be made in a single depositing system that does not include a multiple depositing steps.

In alternative embodiments, each segment of the center-filled confectionery product can have a different characteristic in addition to color and/or flavor. For example, segments can comprise different textures, viscosities, moisture content, fat content, etc. These characteristics in segments can create differences in solubility (e.g. in the mouth) and affect textural and flavor release between the segments as the confectionery product is consumed.

In another embodiment, the center-filled confectionery products can be produced wherein the confectionery streams that form the segments/filling of the final center-filled composition having a different initial processing characteristic than that of its post-processing character. In other words, the segments/filling of the center-filled confectionery product can having one characteristic at the time of processing and another characteristic after processing (e.g. post-processing) and/or at the time of consumption by a consumer (e.g. due to moisture or oil migration between segments/filling of the product).

It should be appreciated that the center-filled confectionery products in embodiments of the present disclosure can be any suitable size or shape such as, for example, a pellet, sphere, disc, cube, cigarette, spiral, heart, etc. The confectionery products can have any suitable thickness. The confectionery shell and/or the filling can comprise particulates, crystals, particles, nonpareils, smaller beads, etc. The particulates may be, for example, confectionery pieces, vegetable pieces, fruit pieces and/or particulates of sugar, polyols, gum or any other suitable food products.

The confectionery segments/filling may also comprise texture changing ingredients that can partially or entirely liquefy the segments/filling over time. Such ingredients may include, for example, acids like lactic acid, malic acid, citric acid and phosphoric acid and enzymes like amylases and proteinases.

It should be appreciated that one or more ingredients such malted products, flavors, sensates, colors (e.g. azo free colors), sweetener, acids, actives and medicaments (e.g. listed below) can go in any segments or fillings of the confectionery products of the present disclosure. Alternatively, the ingredients can be in the form of encapsulation, compaction, granulation and agglomeration to provide, for example, protected and longer-lasting ingredient components such as flavors and sensates. It should also be appreciated that any or all of the confectionery segments/fillings can comprise any suitable number and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dextrin, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

Combinations of sugar and/or sugarless sweeteners may be used in the confectionery. If a low calorie confectionery is desired, a low caloric bulking agent can be used. Example of low caloric bulking agents include: polydextrose; Raftilose; Raftilin; Fructooligosaccharides (NUTRAFLORA®); Palatinose oligosaccharide; Guar Gum Hydrolysate (SUN FIBER®); or indigestible dextrin (FIBERSOL®). However, other low calorie bulking agents can be used.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also, nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

### EXAMPLES

By way of example and not limitation, the following examples are illustrative of various embodiments of the present disclosure.

### Example 1

### Strawberry Striped Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Red Segment

| | |
|---|---|
| Cooked Candy Base | 97.7 |
| Buffered Lactic Acid | 1.2 |
| Flavor | 0.6 |
| Red Coloring | 0.5 |
| Total | 100% |

White Segment

| | |
|---|---|
| Cooked Candy Base | 97.1 |
| Buffered Lactic Acid | 1.2 |
| Flavor | 0.6 |
| White Coloring | 1.1 |
| Total | 100% |

Center Filling

| | |
|---|---|
| Sugar | 49.3 |
| Milk Powder | 20.0 |
| Cocoa Butter and Liquor | 29.4 |
| Soy Lecithin | 0.5 |
| Flavor | 0.01 |
| Water | 0.81 |
| Total | 100% |
| Outer Striped Shell | 81% |
| Filling | 19% |
| Total | 100% |

### Example 2

### Caramel Striped Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Brown Segment

| | |
|---|---|
| Cooked Candy Base | 98.1 |
| Flavor | 1.3 |
| Brown Coloring | 0.6 |
| Total | 100% |

White Segment

| | |
|---|---|
| Cooked Candy Base | 97.6 |
| Flavor | 1.3 |
| White Coloring | 1.1 |
| Total | 100% |

Center Filling

| | |
|---|---|
| Sugar | 49.3 |
| Milk Powder | 20.0 |
| Cocoa Butter and Liquor | 29.4 |
| Soy Lecithin | 0.5 |
| Flavor | 0.01 |
| Water | 0.81 |
| Total | 100% |
| Outer Striped Shell | 81% |
| Filling | 19% |
| Total | 100% |

### Example 3

### Peanut Butter Filled Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Brown Segment

| | |
|---|---|
| Cooked Candy Base | 98.1 |
| Flavor | 1.3 |
| Brown Coloring | 0.6 |
| Total | 100% |

White Segment

| | |
|---|---|
| Cooked Candy Base | 97.6 |
| Flavor | 1.3 |
| White Coloring | 1.1 |
| Total | 100% |

Center Filling

| | |
|---|---|
| Peanut Butter | 100.0 |
| Total | 100% |
| Outer Striped Shell | 81% |
| Filling | 19% |
| Total | 100% |

### Example 4

### Fruit Filled I Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Red Segment

| | |
|---|---|
| Cooked Candy Base | 97.7 |
| Buffered Lactic Acid | 1.2 |
| Flavor | 0.6 |
| Red Coloring | 0.5 |
| Total | 100% |

White Segment

| | |
|---|---|
| Cooked Candy Base | 97.1 |
| Buffered Lactic Acid | 1.2 |
| Flavor | 0.6 |
| White Coloring | 1.1 |
| Total | 100% |

Center Filling

| | |
|---|---|
| Fruit Preserves | 100.0 |
| Total | 100% |
| Outer Striped Shell | 81% |
| Filling | 19% |
| Total | 100% |

### Example 5

### Fruit Filled II Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Red Segment

| | |
|---|---|
| Cooked Candy Base | 97.7 |
| Buffered Lactic Acid | 1.2 |
| Flavor | 0.6 |
| Red Coloring | 0.5 |
| Total | 100% |

White Segment

| | |
|---|---|
| Cooked Candy Base | 97.1 |
| Buffered Lactic Acid | 1.2 |
| Flavor | 0.6 |
| White Coloring | 1.1 |
| Total | 100% |

Center Filling

| | |
|---|---|
| Crushed Fruit Paste | 100.0 |
| Total | 100% |
| Outer Striped Shell | 81% |
| Filling | 19% |
| Total | 100% |

### Example 6

### Milk Chocolate Filled Confectionery Formula

| | |
|---|---|
| Ingredients: | Wet Weight Amount (%) |

Candy Base

| | |
|---|---|
| Sugar | 39.7 |
| High Maltose Corn Syrup | 35.0 |
| Water | 13.3 |
| Cream (18% fat) | 6.5 |
| Coconut Oil and Lecithin | 5.2 |
| Salt | 0.3 |
| Total | 100% |

Red Segment

| | |
|---|---|
| Cooked Candy Base | 97.7 |
| Buffered Lactic Acid | 1.2 |
| Flavor | 0.6 |
| Red Coloring | 0.5 |
| Total | 100% |

White Segment

| | |
|---|---|
| Cooked Candy Base | 97.1 |
| Buffered Lactic Acid | 1.2 |
| Flavor | 0.6 |
| White Coloring | 1.1 |
| Total | 100% |

Center Filling

| | |
|---|---|
| Milk Chocolate | 0.81 |
| Total | 100% |
| Outer Striped Shell | 81% |
| Filling | 19% |
| Total | 100% |

### Example 7

### General Process

For the outer striped, or swirled, portion of the confectionery product, a batch of a candy base is made and cooked at approximately 234° F. The candy base batch is separated into two base batches and cooked further in two phases of approximately 250° F. and approximately 287° F. to remove excess water. The two candy bases are pumped into an in-line mixer where colors, flavors and/or acids are added. After the addition of the colors, flavors and/or acids, the two candy bases are pumped into separate hoppers of a depositor having a temperature of approximately 285° F. to keep the candy in a fluid form.

For milk chocolate as the filling, the milk chocolate is melted (to 110+/−5 F) in a melting tank and pumped into a surge tank. The surge tank keeps it heated at approx 110° F. The milk chocolate is then pumped into a separate hopper (in the center of the depositor) between the two hard candy hoppers. Alternatively, the process may also include a cooking step to ensure the filling attains its appropriate physical state.

A manifold comprising a number of nozzles rests below the chocolate hopper. The candy from the two hoppers travels into their own separate alternating external passages of the nozzle/manifold assembly and out of the nozzle/manifold assembly from a number of external concentric passages into a tray having a plurality of moulds. While a layer of the two candies is being deposited in the bottom of the moulds, the chocolate exits through the center of the nozzle (at bottom of the manifold directly over the moulds on the conveyor) and enters the manifold in the same way that the candy enters. A predetermined amount of chocolate is deposited, and the chocolate flow is discontinued. At the same time, the candy streams continue to be deposited around and over the chocolate center in the moulds. The design of the depositor system is such that the chocolate enters the outer candy streams in such a way as to have the candy streams completely enclose the chocolate during the depositing process. These steps can be referred to as a stroke and can take place over a short period of time, for example, a couple of seconds.

The depositor is set to achieve 50-70 strokes per minute. The trays containing the deposited masses in the moulds are conveyed to a cooling tunnel having a temperature of approximately 55° F. The center-filled candy is cooled to room temperature. After the candy has been cooled and is in a hardened form, the moulds are inverted 180 degrees. The center-filled candy is ejected from the inverted moulds by depressing ejection pins at the bottom of the moulds. The ejected candy falls onto a conveyor belt, which transports the candy under a metal detector station, which automatically rejects any product contaminated with metal. The center-filled candy is conveyed directly to the flow wrappers and the roll wrapper.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A confectionery product comprising a hard confectionery shell surrounding a filling, the hard confectionery shell comprising a plurality of segments having different colors, wherein the filling is selected from the group consisting of a liquid, a paste, a powder, a hard confectionery and combinations thereof.

2. The confectionery product of claim 1, wherein the filling comprises a component selected from the group consisting of a chocolate, compound coating, cocoa powder, cocoa liquor and combinations thereof.

3. The confectionery product of claim 1, wherein the filling comprises a component selected from the group consisting of fondant, caramel, nougat and combinations thereof.

4. The confectionery product of claim 1, wherein the filling comprises a component selected from the group consisting of peanut butter, nut paste and combinations thereof.

5. The confectionery product of claim 1, wherein the filling comprises a fruit-based product.

6. The confectionery product of claim 5, wherein the fruit-based product is selected from the group consisting of fruit pieces, freeze dried fruit, drum dried fruit, infused fruit, crushed fruit, squeezed fruit, fruit extract, fruit oil, fruit paste, fruit powder, fruit particulates, fruit juice and combinations thereof.

7. The confectionery product of any of the preceding claims, wherein the segments of the hard confectionery shell have varying widths.

8. The confectionery product of claim 1, wherein the hard confectionery shell comprises at least one ingredient selected from the group consisting of malted products, sweeteners, flavors, colors, sensates, acids, medicaments, actives and combinations thereof.

9. The confectionery product of claim 1, wherein the filling comprises at least one ingredient selected from the group consisting of malted products, sensates, medicaments, actives and combinations thereof.

10. The confectionery product of claim 1, wherein the confectionery product comprises little or no trans fat.

11. The confectionery product of claim 1, wherein the confectionery product comprises little or no saturated fat.

12. The confectionery product of claim 1, wherein at least one of the group consisting of the hard confectionery shell, the filling and combinations thereof comprises a texture changing ingredient selected from the group consisting of acids, enzymes and combinations thereof.

13. A method of making a hard center-filled confectionery product, the method comprising:
dispensing a first confectionery through a first outer passage of a nozzle;
dispensing a second confectionery through a second outer passage of the nozzle, the second confectionery comprising at least one different characteristic from the first confectionery;
dispensing a filling through an inner chamber of the nozzle; and
co-depositing the first confectionery, the second confectionery and the filling, wherein the first confectionery and the second confectionery form a plurality of adjacent segments that completely surround the filling.

14. The method of claim 13, wherein the characteristic is selected from the group consisting of color, flavor, texture, moisture content, fat content and combinations thereof.

15. The method of claim 13, wherein the filling is selected from the group consisting of a liquid, a paste, a powder, a hard confectionery and combinations thereof.

16. The method of claim 13, wherein the filling comprises a component selected from the group consisting of a chocolate, compound coating, cocoa powder, cocoa liquor and combinations thereof.

17. The method of claim 13, wherein the filling comprises a component selected from the group consisting of fondant, caramel, nougat and combinations thereof.

18. The method of claim 13, wherein the filling comprises a component selected from the group consisting of peanut butter, nut paste and combinations thereof.

19. The method of claim 13, wherein the filling comprises a fruit-based product selected from the group consisting of fruit pieces, freeze dried fruit, drum dried fruit, infused fruit, crushed fruit, squeezed fruit, fruit extract, fruit oil, fruit paste, fruit powder, fruit particulates, fruit juice and combinations thereof.

20. A method of making a hard center-filled confectionery product, the method comprising:
dispensing a plurality of streams of a first confectionery in fluid form through corresponding first outer passages of a nozzle;
dispensing a plurality of streams of a second confectionery in fluid form through corresponding second outer passages of the nozzle, the second confectionery comprising at least one different characteristic from the first confectionery;
dispensing a filling through an inner chamber of the nozzle; and
depositing a portion of the first confectionery streams and the second confectionery streams into a mould;
depositing the filling on top of the portion of the first confectionery streams and the second confectionery streams; and
depositing the first confectionery streams and the second confectionery streams in the mould to form a plurality of adjacent segments that completely surround the filling.

21. The method of claim 20 further comprising cooling the first confectionery streams and the second confectionery streams in the mould.

22. A method of making a hard center-filled confectionery product, the method comprising:
partially enrobing a filling within a confectionery shell using a concentric nozzle, the confectionery shell comprising a plurality of segments having different characteristics;
depositing the partially enrobed filling in a cavity of a mould;
completely enrobing the filling component within the confectionery shell; and
setting the confectionery shell within the mould cavity to form the hard center-filled confectionery product.
